(19) United States
(12) Patent Application Publication
(10) Pub. No.: US 2023/0375895 A1
(43) Pub. Date: Nov. 23, 2023

(54) BINARY TREE PHASED ARRAYS AND CONTROL METHODOLOGIES

(71) Applicant: U.S. Army DEVCOM, Army Research Laboratory, Adelphi, MD (US)

(72) Inventors: Justin R. Bickford, Damascus, MD (US); Pak S. Cho, Silver Spring, MD (US)

(21) Appl. No.: 17/747,466

(22) Filed: May 18, 2022

(51) Int. Cl. G02F 1/29

(52) U.S. Cl. CPC G02F 1/292

(57) ABSTRACT

Novel binary tree phased arrays provide a linear phase distribution to 1- or 2-dimensional array outputs. This phase distribution applies to any signal carrier (e.g., radio frequency, light, sound, etc.). The approach uniquely distributes the phase control in a cascading stage structure to control the phase distribution with a minimal number of control lines. The low number of control lines vastly minimizes the complexity required by state-of-the-art approaches. They may be used for beam steering applications.

### GOVERNMENT INTEREST

The invention described herein may be manufactured, used and licensed by or for the U.S. Government without the payment of royalties thereon.

Some of the research underlying the invention was supported by the U.S. Army Development Capabilities Command Army Research Laboratory (ARL) under Contract Nos. W15P7T-19-D-0038 and W911QX-20-F-0023.

### BACKGROUND OF THE INVENTION

### Field

Embodiments of the present invention are generally directed to phased arrays, and more particularly to binary tree fed phased arrays and control methodologies thereof, specifically for beam steering applications.

### Description of Related Art

Phased arrays allow users to steer a farfield beam's direction with no moving parts. Traditionally, phased arrays are composed of a splitting network to distribute a single source signal into a desired number of copies. A phase delay is then applied to each one of these signal copies, individually. These delayed signals are then physically distributed and launched into emitters that spread their energy into the farfield. The physical distribution and relative phase shift of these are controlled to steer the beam's farfield direction.

An example of this architecture is disclosed in S. Miller et al., “512-Element actively steered silicon phased array for low-power LIDAR,” Conference on Lasers and Electro-Optics, OSA Technical Digest (Optica Publishing Group, 2018), herein incorporated by reference in its entirety. With 512 individually addressed phase shifters in this phased array, it must rely on very complex control electronics, and requires extensive calibration. The high wirebond count lowers yield and increases packaging cost, and the chip real-estate is large (proportional to cost). More, individually addressing more phase shifters this way becomes prohibitive.

In light of the foregoing, improvements are desired.

### BRIEF SUMMARY OF THE INVENTION

Embodiments of the present invention are directed to novel binary tree phased arrays and control methodologies. The binary tree phased arrays can be configured to provide a linear phase distribution, for instance, to 1- or 2-dimensional array outputs. This phase distribution applies to any signal carrier (e.g., radio frequency, light, and sound). The approach uniquely distributes the phase control in a cascading stage structure to control the phase distribution with a minimal number of control lines. The low number of control lines vastly minimizes the complexity required by state-of-the-art approaches. They may be used for beam steering applications.

According to embodiments, the phased arrays comprise a signal input; many signal outputs; a binary tree comprising a plurality of stages between the signal input and the signal outputs, a plurality of phase shifters to apply a phase shift to signals in the binary tree, and a controller configured to provide control signals to the phase shifters. There may be one single input signal, but arrayed inputs could also be provided. The output will be an array with number of outputs N in each dimension, as provided, being an even number. The binary tree is designed for outputs based on an exponent of 2; but the number of outputs N can be truncated in some implementations and embodiments. The number of outputs N may be as low as four but may be usefully applied to array sizes of 64 (2⁶) or more, such as up to 4096 (2¹²) or perhaps higher.

In the binary tree, the stage closest to the signal input receives the signal input, each consecutive stage receives the outputs of the preceding stage, and the last stage connects to the N signal outputs. The stages include phase shifters. The first stage closest to the signal input includes two phase shifters, each consecutive stage including twice as many phase shifters as the previous one, and the last stage including N phase shifters which connect to the N signal outputs.

The phase shifters may be grouped. For instance, in some embodiments, half the phase shifters in each stage may be associated with a first group and the other half of phase shifters in each stage may be associated with a second group. The controller provides a first control signal to the first group of shifters at each stage and a second control signal to the second group of phase shifters at each stage. More, the control signals are further configured to provide an initial amount of phase shifting at stage closest to the N signal outputs and effectively doubling amount of that initial phase shifting amount for each consecutive stage closer to the signal input.

The first control signals provide a first linear phase ramp and the second control signals provide a second linear phase ramp. In general, the amount of phase shifting for the phase shifters at each stage is between 0 and a radians. Due to the complementary nature of the phase shifting, the amount of phase shifting for the phase shifters at each stage can be limited to between 0 and ±π radians.

In the binary tree, with two groups of phase shifters at each stage, there may be as few as 2*log₂(N) control lines going to the plurality of phase shifters. Since the phase shifters use the same control signals, it may be possible to have as few as 2 control lines to the plurality of phase shifters. Additional hardware modifications would be necessary to account for the latter. In some embodiments, by setting the phase shifting of one group of phase shifters to 0 radians, those phase shifters can be effectively eliminated. This can reduce the number of phase shifters and control lines by half. Thus, there could be as few as log₂(N) separate control lines to the plurality of phase shifters. And, assuming phase shifters can use the same control signals, there may be as few as one control line to the plurality of phase shifters.

In some embodiments, the output array of the phased array is one-dimensional, 1×N. In others, the output array is two-dimensional, M×N, where M is an even number of at least 4. For instance, the phased array may comprise a plurality of second binary tree phased arrays comprising a plurality of stages between 1×N signal inputs and M×N signal outputs. The stage closest to 1×N signal inputs receives the 1×N signals. Each consecutive stage receiving the outputs of the preceding stage. The last stage connects to the M×N signal outputs.

The phased array can use a plurality of signal splitters to split signals for each stage. While it may be assumed that the splitting error is negligible and ignored, in some instances, the phased array can be used to compensate for actual errors in others. To this end, the controller may be configured to control the phase shifters to also correct variations on the output of the signal splitters.

We also teach methods of forming a phased array. They may comprise deciding the number of outputs for the phased array; determining the number of stages for the phased array based on the number of outputs; arranging the plurality of phase shifters in the stages to form the binary tree; and configuring and control phase shifting for the phase shifters in each of the stages.

And we disclose methods of using a phased array. They may comprise controlling the phase shifters of the first group; and controlling the phase shifters of the second group among other steps.

These and other embodiments of the invention are described in more detail, below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments, including less effective but also less expensive embodiments which for some applications may be preferred when funds are limited. These embodiments are intended to be included within the following description and protected by the accompanying claims.

FIG. 1A-1E show various aspects of a binary tree phased array architecture according to embodiments.

FIG. 2 is a detailed schematic for a 1-D binary tree phased array embodiment.

FIG. 3 is an illustration of an ideal optical phased array steering a farfield beam of light in one dimension according to embodiments of the present invention.

FIGS. 4A-4C are plots showing simulated farfield beam shape and position for different steering directions.

FIGS. 5A-5C are images of experimentally steered optical beams at different steering directions.

FIG. 6 shows a methodology for forming binary tree phased arrays according to embodiments.

FIG. 7A shows a schematic of another 1-D binary tree phased array embodiment. FIG. 7B shows its output ramp.

FIG. 8 shows a photonic schematic layout of a 1-D binary tree phased array embodiment for light having 128 outputs. FIGS. 8A and 8B are magnified views thereof.

FIGS. 9A-9C show a 2-D binary tree phased array according to an embodiment.

FIG. 10 is a schematic of a 1-D binary tree phased array embodiment which uses just one group of phase shifters.

### DETAILED DESCRIPTION

We will now present our novel binary tree phased array architecture and control methodologies. The binary tree phased arrays can be configured to provide a linear phase distribution to 1- or 2-dimensional array outputs. This phase distribution applies to any signal carrier (e.g., radio frequency, light, sound). The approach uniquely distributes the phase control in the signal fan-out or cascading structure to control the phase distribution with a minimal number of control lines. The low number of control lines vastly minimizes the complexity required by state-of-the-art approaches and is the key value of this invention. By distributing the groupings of phase shifters within a cascading stage arrangement (rather than applying them aft of it), you can control the linear phase delay across the 1×N element output array using less control lines than N.

Thus, novel binary tree phased arrays according to embodiments systematically distribute the phase delay within the splitting network in unique arrangements or groupings of phase shifters. These groupings are vastly smaller in number, e.g., on the order of log₂(N), than the quantity of outputs, N. With this novel phased array architecture, there may be as few as 2*log₂(N) control lines for the entire binary tree phased array. If the phase shifters are configured to use the same control signals, then it may be possible to have even as few as 2 control lines to the plurality of phase shifters. Additional hardware modifications may be necessary to account for the latter arrangement. But even these numbers may be halved with additional refinements. The distribution of phase shift in the linear ramp is sampled by each output. This linear phase delay ramp, coupled with a uniform output emitter distribution, results in a simple means of controlling farfield steering beam direction with a small number of control lines.

Furthermore, by accounting for 2π phase wrappings, then choosing to apply complementary control signals across the control lines, a linear phase distribution which is positive in slope or negative in slope can be created. Additionally, the complementary control signals need only be between 0 and ±π (or [0, ±π]) in strength, so a power savings of one-half can be achieved, and a reduction in phase variance can be achieved. This increased robustness to manufacturing improves the resulting distribution, simplifying calibration. The control of each stage allows for further refinements to be made.

While the examples described herein are primarily of an optical beam former for steerable free-space optical communications and lidar applications, we believe the invention is pertinent to any RF, optical, sonic, or other phenomenon that obeys coherent interference.

We use the following definitions for RF, light, and sound herein. RF (radio frequency) is a conventional term for electromagnetic radiation that spans frequencies from approximately 100 kHz to approximately 1 THz. Light is also electromagnetic radiation and spans from approximately 1 THz to approximately 1 PHz. We believe our novel methodology applies to all coherently interferable phenomena, so the entire electromagnetic spectrum is, at least theoretically, its domain. Since sound (acoustics) can also be coherently interfered, the methodology also applies to it as well. Sound extends in frequency beyond what humans hear. Most animals can only perceive sounds in the range of approximately 10 Hz to approximately 200 kHz. The spectrum of pressure waves in a medium extend further in both directions than that, but it may not be considered human-audible sound in that range.

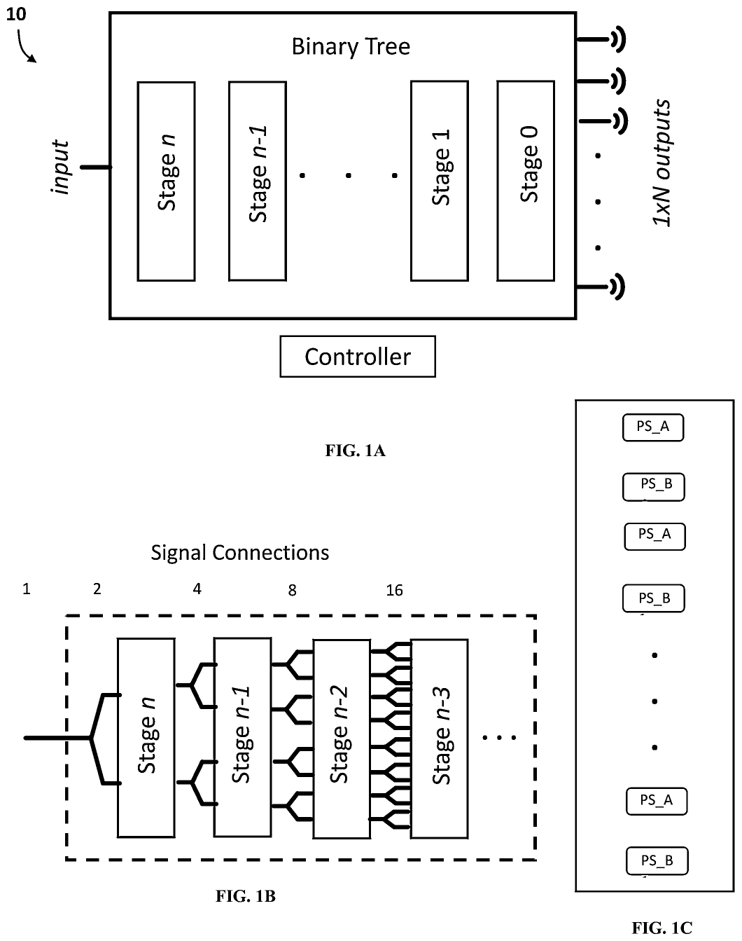

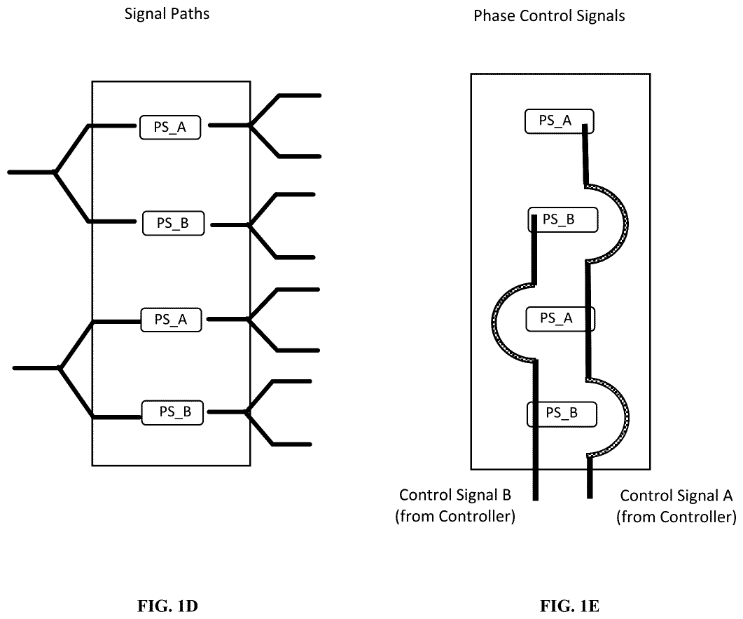

We begin the discussion of our novel binary tree phased array architecture embodiment having a one-dimensional (1-D) array of outputs, 1×N. FIGS. 1A-1E show various aspects of this architecture.

The phased array is a collection of emitters arranged in an organized way (often a linear or rectangular 2-dimensional array), where the outputs emit a copy of a common signal with a prescribed phase delay, each. For any phenomenon that obeys constructive and destructive interference due to principle of coherence (e.g., RF, light, sound), the relative phases of the signal output by these emitters can be prescribed to culminate in a single beam of concentrated energy in the far field.

As shown in FIG. 1A, the phased array 10 provides a network of signal pathways between one or more inputs and outputs. Here, there are a single signal input and a one-dimensional array of N signal outputs. We form the network as a binary tree structure. It is comprised of a plurality of interconnected stages positioned between the signal input and the N signal outputs, labeled Stage 0 to Stage n, going from right to left from the output to the input. n is one less than the total number of stages in the phased array. Later, we explain the numbering convention we used. The stage closest to the signal input (Stage n) receives the signal input, each consecutive stage receives the outputs of the preceding stage, and the last stage (Stage 0) connects to the N signal outputs. The tree structure may be thought of as cascading stages with the output of the preceding stage going to the next stage.

The number of signal connections doubles with each consecutive stage going from the input to the outputs (although, this may not be the case for the last stage if the number of outputs are truncated as later discussed). Thus, as shown in FIG. 1B, a single signal input goes to 2 signals at Stage n, 4 signals at Stage n−1, 8 signals at Stage n−2, and then to 16 signals at Stage n−3 (if present) and so forth for any additional stages. The signals are split at each stage with binary splitters which split the input signal into two identical outputs. The splitters may be located within the stages or between stages as shown.

These signal carriers (e.g., RF, light, and sound) can convey any desired information. They could be used to broadcast voice or music, images and video, radar signals, internet traffic. The signal splitters will be selected based on the nature of the signal, e.g., electrical, light, sound, etc.

Each of the stages includes multiple phase shifters PS uniquely arranged in pairs of two. The stage closest (Stage n) to the input includes two phase shifters, each consecutive stage includes twice as many phase shifters as the previous one, and the last stage (Stage 0) includes N phase shifters which connect to the N signal outputs.

The phase shifters will be selected based on the nature of the signal too. For optical signals, the phase delay could be based on electro-optic, magneto-optic, acousto-optic, thermo-optic, free-carrier, phase-change, and other phenomena driven phase shifters (these all exist in a variety of forms today). The optical emitters could be any termination of a waveguide, grating emitter, optical fiber, plasmonic or other scatterer. RF phase control components could be based on a circuit resonance shift (e.g., phase-locked loop or otherwise), signal mixing, true-time delay, ferroelectric or other phenomena. RF emitters could be any termination of a transmission line, wire pair, whip or patch antenna, horn, dish, or other scatterer. Sound phase delay could be based on signal mixing, true-time delay, direct synthesis (electrical conveyance), or other means. The sound emitters could be speakers, piezoelectric, or some form of conduit termination.

FIG. 1C shows an example of an exemplary stage in the binary tree phased array with a number of phase shifters (PSs). Half the phase shifters in each stage are associated with a first group and the other half of phase shifters in each stage are associated with a second group. We refer to these groups as A and B herein, but other naming conventions can be used.

The phase shifters are labelled PS_A and PS_B to denote which group they belong. Notionally, for each stage, each phase shifter PS is configured to provide a desired phase augmentation (e.g., delay or addition) which responds to a control signal (e.g., a voltage) identically. During manufacturing, there will be a variation in their performance. We assume this variation is negligible in some cases. Although, in others, we can use the phased array to correct systematic errors in phase delay differences in the outputs of the splitters. While this may sound trivial, it is actually quite helpful to correct this common type of systematic error. If the splitters in each stage erroneously produce a phase difference in their two outputs, where they are supposed to produce zero relative phase difference, the stage aft of this systematic error can further correct for it. The phase shifters are preferably variable so that they can vary the phase augmentation as needed. They are alternatively arranged in each of the stages, i.e., A-B, A-B-A-B, A-B-A-B-A-B-A-B, and so forth for each consecutive stage. We arranged them vertically, but other geometries could be used.

FIG. 1D shows the second stage from the input (Stage n−1). This stage always includes four phase shifters. That is, the two outputs from the first stage (Stage n) each split to provide four inputs for Stage n−1 shown. There are four signal paths, one to and from each of the phase shifters in the stage. Each phase shifter augments the signal going through it, for instance, imposing a phase delay or addition. After phase shifting occurs in this stage, the four augmented signal paths each split again to provide eight signal paths.

FIG. 1E shows the control signals for the four phase shifters in FIG. 1D. We tie all of the A phase shifters in a stage together so that they all respond with the same phase delay for a given control signal to that stage. We do the same to all the stages respectively. And then we do this again to all the B phase shifters. You will now have an A_side control signal for each stage and a B_side control signal for each stage. The separate control lines may supply a different control signal (e.g., a voltage) to A phase shifters and B phase shifters, respectively. This will be true for any number of phase shifters in any stage: two signal lines ties and control the two sets of phase shifters. For any desired 1×N output array, assuming two control lines for each stage (one for the PS_As and one for the PS_Bs), there will now be 2*log₂(N) control signals in total. This is the most basic premise of the approach. Often in practice, though, one may add a single common connection to reference all these control signals for a total of 2*log₂(N)+1 connections.

A controller is provided that is configured to provide control signals to the phase shifters. It may be a computer or microprocessor, for instance, that includes computer-executable instructions (and/or code) which when executed is configured to implement the phase control methodology. According to embodiments, the controller provides a first control signal to the first group of shifters (e.g., PS_As) at each stage and a second control signal to the second group of phase shifters (e.g., PS_Bs) at each stage. These control signals are further configured to provide an initial amount of phase shifting at stage closest to the N signal outputs and effectively doubling amount of that initial phase shifting amount for each consecutive stage closer to the signal input. In other words, the phase shifters double the phase multiplication with each increasing stage count number n.

The accumulated phase for each signal path (route) from the signal input to each element in the output array creates a discretely sampled linear ramp distribution. The slope of the ramp is dictated by the initial phase shift values chosen for A or B. In some implementations, the controller is configured to provide control signals to the stages so that A phase shifters PS_A impart a first linear phase ramp and the B phase shifters PS_B impart a second linear phase ramp. The first and second linear phase ramps may be positive or negative in certain cases. However, this is not a requirement in all cases. The ramps need not be positive or negative and can be any sloped values.

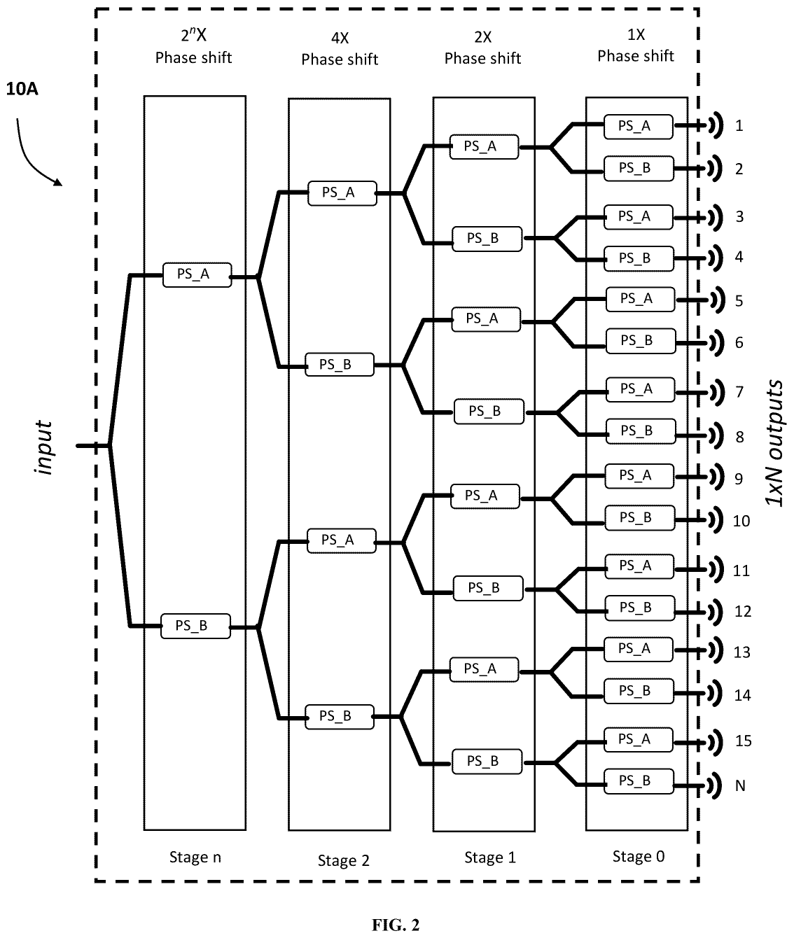

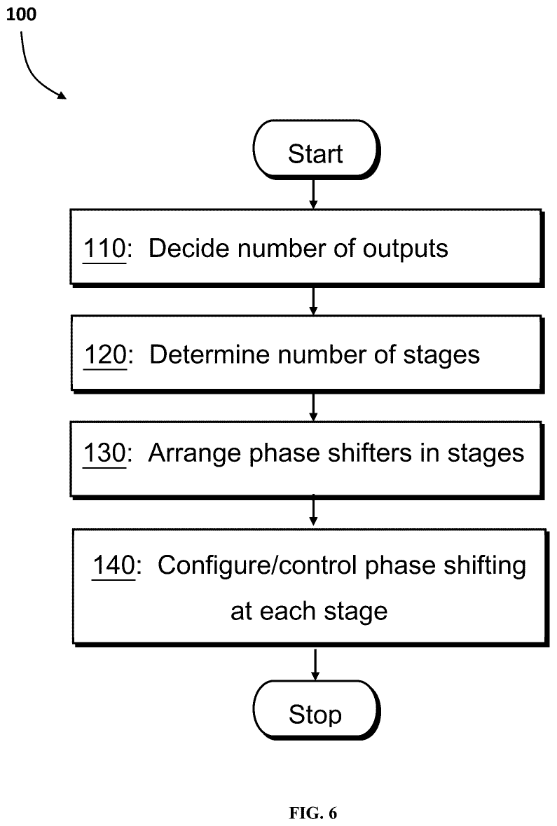

Putting the aforementioned teachings together, in FIG. 2 we present a detailed schematic for a binary tree phased array embodiment 10A having a one-dimensional (1-D) array of outputs, 1×N. It actually contains 1×16 outputs, but we present a methodology as to how to generically form the binary tree phased array base on any arbitrary number of outputs, N, and stage count number, n. We discuss this more with respect to binary tree forming methodology 100 in FIG. 6 later. It should be apparent how the binary tree phased array scales for greater number of outputs by including additional stages included.

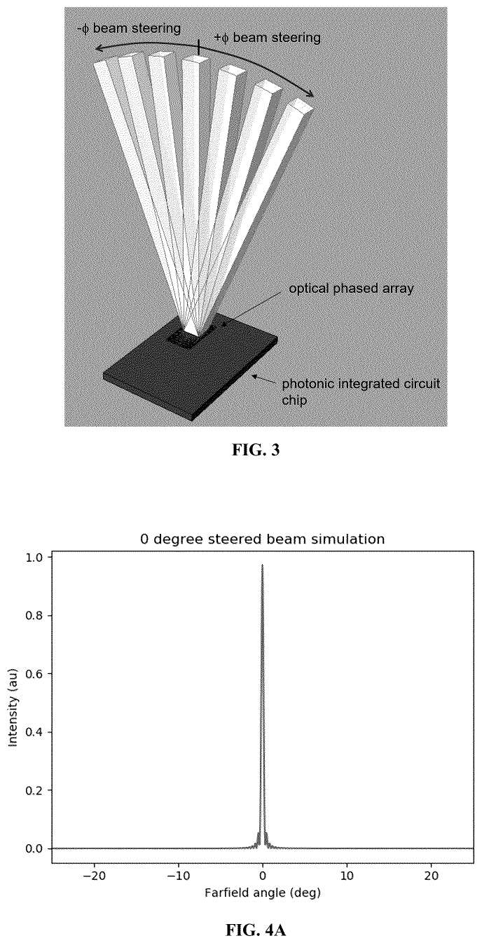

Beam steering is a key application for the binary tree phased arrays. We will briefly discuss the beam steering. FIG. 3 is an illustration of an ideal optical phased array steering a farfield beam of light in one dimension according to embodiments of the present invention. It shows an optical binary tree phased array on a photonic integrated circuit chip host. The beam is optionally steered to any angle ϕ from the normal direction to the left or right based on phase shifts applied to each stage. We refer to angle ϕ as the steering angle hereinafter. There are shown there a composite sampling of several possible beam directions to illustrate the concept. In use, only one beam direction would be active at a time.

The steering angle ϕ can be controlled by phase shifting. We will denote a phase shift amount as Δϕ. To begin with, the phase shift amount (Δϕ) is as follows: its range is −π≤Δϕ≤+π (or [0, +2π] as they are equivalent). You can technically apply Δϕ values outside this range, but that is superfluous, since it will just phase-wrap back into the same range. The phase shift amount (Δϕ) in the stage closest to the outputs (Stage 0) is chosen based on the direction where you want the beam to be steered. The Δϕ value controls the slope of the resulting linear Δ phase slope output distribution (which is discretely sampled by N outputs). We call this the initial phase amount. It is simply 1×Δϕ in Stage 0. The amount of phase shifting is doubled in each preceding stage getting closer to input.

The Δϕ values may vary as needed and thus the output values for the phased array. For example, if we set Δϕ=+π/4 radians if you wanted this set of outputs: 0, +π/4, +2π/4, +3π/4, +4π/4, +5π/4, . . . +(N−1)π/4. In another example, Δϕ=−0.1472894 radians, yielding an output set of: 0, −0.1472894, −0.2945788, −0.4418682, −0.5891576, . . . (N−1)(−0.1472894) radians.

The next part depends on how a designer chooses to utilize this novel binary tree phased array and should be known by those skilled in the art who intend to use it. If one uses the output array to feed a set of optical emitters (as is our first intended use case), then each of these emitters constructively interferes with each of the others in the farfield to generate an aggregate optical beam which can be thought of as projecting from the array at a steering angle of π from normal. To get from a desired π to the Δϕ value, you need to rigorously apply phased array theory. There are many textbooks and journal articles available on the subject of RF phased array design. One recently-published exemplary textbook is: Arik D. Brown. Active Electronically Scanned Arrays: Fundamentals and Applications. Wiley-IEEE Press. (2021). ISBN 978-1-119-74905-9. Here is another: Robert C. Hansen, Phased Array Antennas. Wiley Press. Second edition. (2009). ISBN 978-O-470-40102-6.

The gist, though, may be captured in this approximation for the phase shift (Δϕ):

Δϕ≈ϕ*2π/a sin(λ/s), (1)
where
s is the physical spacing of the emitters;
λ is wavelength; and
π the steering direction

The steering direction π and a sin( ) share units (whether radians or degrees); λ and s also share units (of length). The same approximation holds for RF as well as sonic phased array applications. Of course, more complex equations for computing the phase shift (Δϕ) based on the steering angle ϕ, may be used in other implementations and embodiments. Really, any medium that shares the same principle of coherent interference applies. The binary tree phased arrays can be implemented in a fixed hardware, allowing Δϕ to be adjusted “on the fly” as needed. Updated Δϕ values can be entered into the controller in a manual or automated fashion.

The architecture of the binary tree phased array generates a linearly sloped output. Say you are trying to broadcast a signal off in a direction ϕ. It does not matter whether it uses an RF carrier, light (which is really just a higher frequency electromagnetic radiation than RF), or sound. Each of those signal examples can be expressed as a single (or set) of frequencies and amplitudes which change over time to convey information. Each of those constituent frequencies can be described with a phase term (along with their other factors). When the signal is split in the binary tree phased array, all the copies of that input signal attain a different phase term. The distribution of those phase terms follows the description above. When the outputs are emitted, they constructively interfere in the far field.

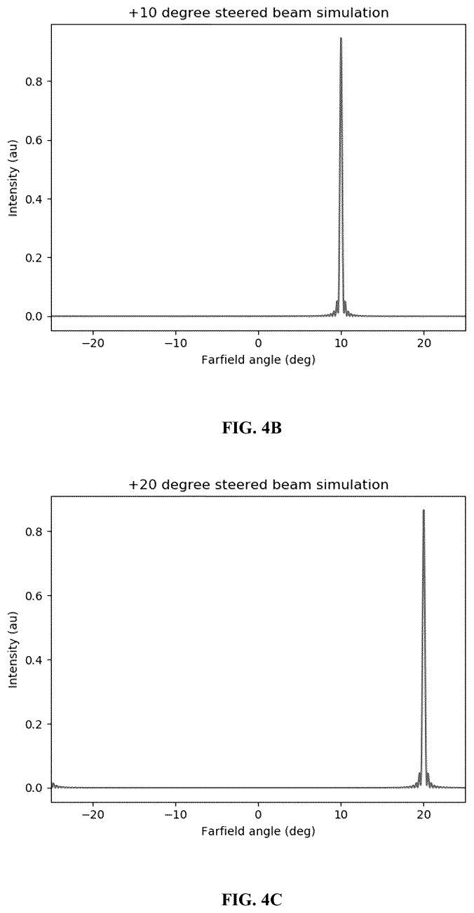

FIGS. 4A-4C are plots that show the simulated farfield beam shape and position for different steering directions π examples of 0, +10, and +20 degrees (0, +0.174, and +0.349 radians) from normal, respectively. The vertical axis represents the farfield intensity, while the horizontal axis represents the angular field the beam is emitted into, that is, the steering angles π as depicted in FIG. 3. An N=128 (2⁷) 1-D output array was utilized. The emitter spacing was 2 microns and the wavelength of light was 1550 nanometers.

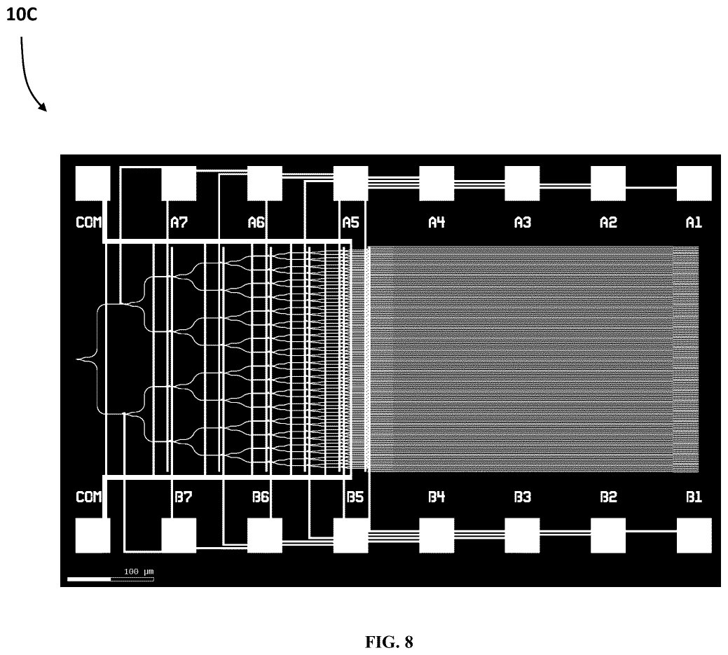

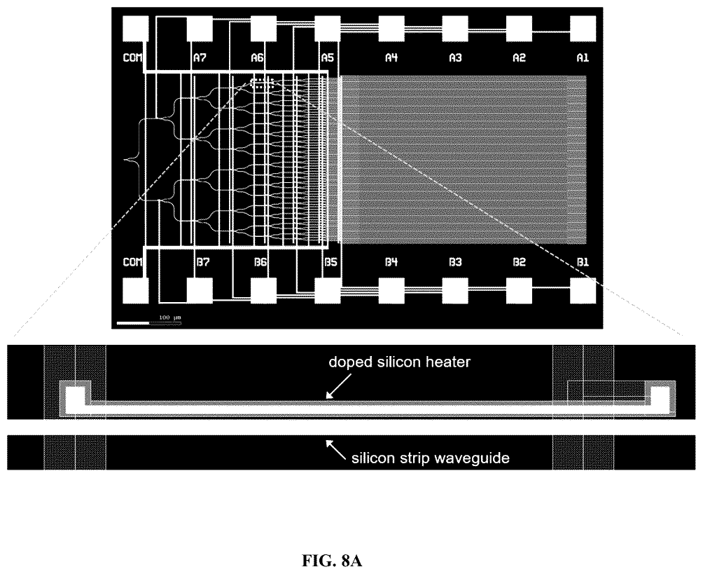

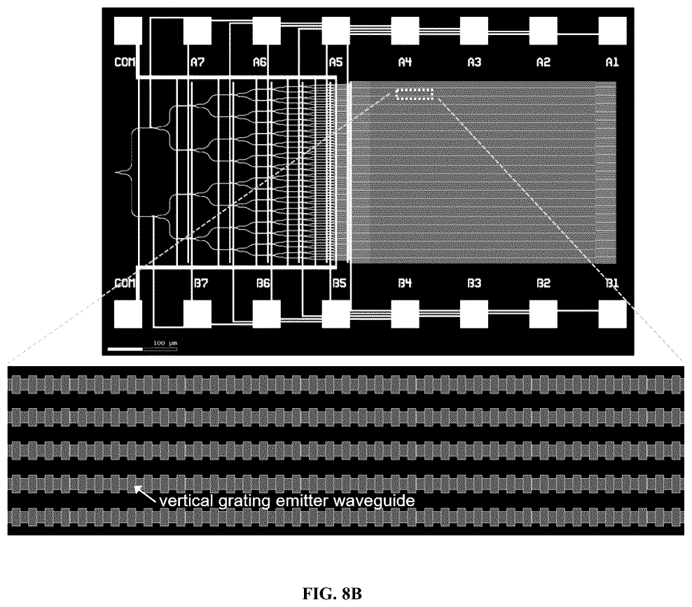

The beam steering was implemented in an integrated photonics platform with a configuration matching the simulated case above. A layout of this optical phased array is shown in FIG. 8.

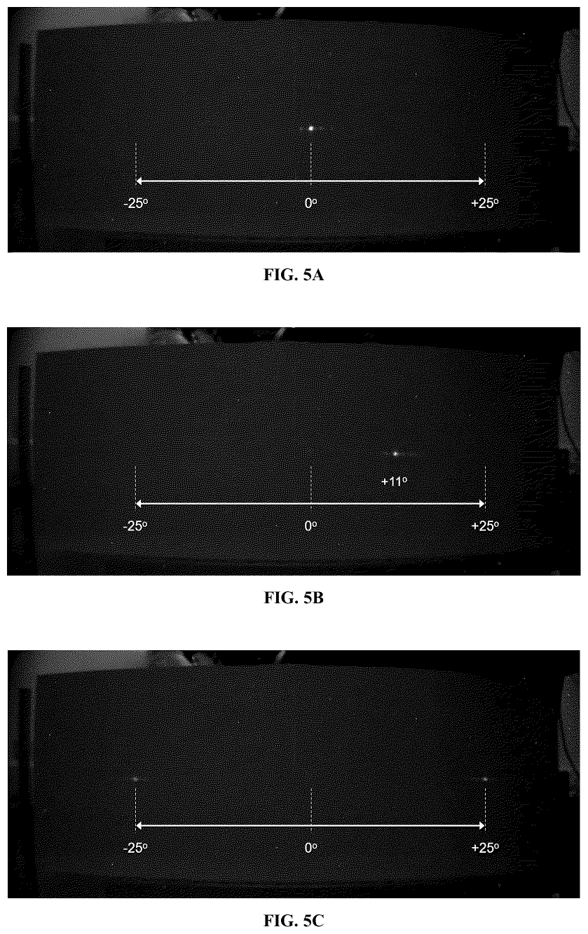

FIGS. 5A-5C are images depicting examples of experimentally steered optical beams at 0 degree (0 radians), +11 degree (+0.192 radians), and ±25 degrees (±0.436 radians), respectively. Other farfield energy patterns can be purposely created, though, many applications desire a single beam. These figures demonstrate the farfield beam being steered which is the principal purpose of the invention.

FIG. 6 shows a methodology 100 for forming a binary tree phased array according to embodiments of any number of outputs. In step 110, we decide the number of outputs. The output may be 1- or 2-dimensional. We will begin the discussion for the 1-dimensional case. There is typically a single input for the phased array. It provides an arrayed output of 1×N signals. The number of outputs, N, may be thought of as a width. N will always need to be an even number integer given the architecture for the binary tree.

The smallest output value N our architecture can address is technically 2, but that would be trivial and nonsensical. Ideally, N will be a power of 2 (e.g., 4, 8, 16, 32, 64, 128, etc.), although, the array can always be truncated to whatever number is desired. A practical minimum for N might be as low as say 4 (2²), 8 (2³) or 16 (2⁴), but those cases might have only limited use given their small size. The array is probably most useful when applied to array sizes of 64 (2⁶) or higher. Although, there is no theoretical limit to how high N can be. Today's applications likely do not need N higher than 4096 (2¹²), but that does not mean our architecture is limited to that value.

As an example of a truncated tree, consider the architecture can support ten stages or 1024 (2¹⁰) outputs, but the designer only needs 1000 outputs. The designer can simply not use or eliminate 24 of the outputs. If a designer wants to truncate the number of outputs, the outputs chosen should be contiguous in order to preserve the linear phase ramp distribution needed to steer the far-field beam. Thus, the end/terminal outputs could be omitted, but not internal/central outputs. For instance, for 1000 out of 1024 outputs, the designer can choose outputs 3, 4, . . . , 1002 and exclude outputs 1, 2 and 1003-1024. But the designer should not arbitrarily choose outputs 1, 2, (skip 3), 4, . . . , 1002, 1003, (skip 1004), 1005, etc.

We simply number the outputs 1 to N in a downward vertical direction for their reference (see FIG. 2). But this is largely arbitrary and other naming/reference conventions can certainly be used.

In some embodiments, the array could be expanded in a second dimension. The most straightforward way to expand to the second dimension is to add one copy of a similar splitter binary tree (say 2^{m}=M outputs tall) to each of the N outputs, thus giving a final M×N output array. M might be thought of a height and N might be thought of as a width.

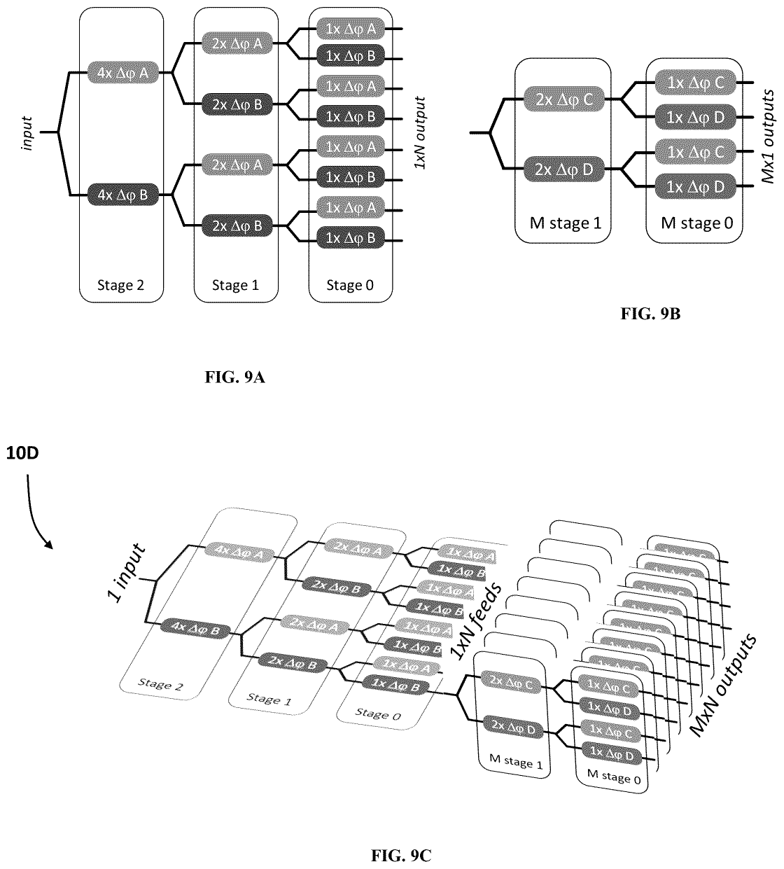

Like N, M will always need to be an even number integer given the architecture for the binary tree. And, ideally it is power of 2, although, this is not a requirement. The range for M is similar to N. They can be the same or different as may be desired. An example is shown in FIGS. 9A-9C further discussed below.

In step 120, we decide the number of stages n in the novel binary tree phased array. Again, we start the discussion for 1-D embodiments. The number of stages n needed is based on the number of outputs 1×N. We use a logarithmic function with a base of 2. It is equal to log₂(N). For N of powers of 2 log₂(N) will be an integer value. For instance, if N=16, then log₂(16)=4; so, four stages would be used. However, if N is not a power of 2 then log₂(N) will be a non-integer value. In such cases, we round up the logarithmic term up to the next higher integer for the number of stages. For instance, if N=12; log₂(12)=3.585; so, we round up to 4 and would use four stages. There will just be fewer phase shifters in Stage 0 for N=12 outputs compared to N=16.

The naming or numbering of the stages is largely arbitrary. We chose to begin the stage count number, Stage n, at 0 (rather than 1) for the stage closest to the outputs for simplicity with working exponents. It is just one less than the total number of stages present in the phased array. This makes the amount of phase shifting for each stage equal to 2 to the power of that stage count number, or simply 2ⁿ. Thus, for Stage 0, 2⁰=1.

The same approach can be used for M in 2-D embodiments. We presume a 1-D input of 1×N and an 2-D output of M×N. Thus, the 1-D process can be repeated for the second dimension in the 2-D implementations and embodiments, if desired, in which the stage count number m in the second dimension is based on the number of outputs M in that dimension. We again begin the count at 0. It uses the same logarithmic function with a base of 2. It is equal to log₂(M). For M of powers 2 log₂(M) is an integer. If M is not a power of 2, we round up to next integer value.

In step 130, we arrange the phase shifters in the various stages. There are multiple phase shifters to apply a phase shift to signals, with each stage distributing the signal to each of its phase shifts. We start the discussion with the 1-D case. The stage closet to the signal input (Stage n) will have two phase shifters. Each consecutive stage includes twice as many phase shifters as the previous one. To accomplish this, the output of a phase shifter in the preceding stage splits and goes to two phase shifters in the present stage. And the last stage closet to the outputs (Stage 0) includes N phase shifters which connect to the N signal outputs.

The phase shifters are grouped in two distinct groups. We call them the groups A and B. Half the phase shifters in each stage are associated with the first group (e.g., A) and the other half of phase shifters in each stage are associated with the second group (e.g., B). They are alternatively arranged in each of the stages, i.e., A-B, A-B-A-B, A-B-A-B-A-B-A-B, and so forth for each consecutive stage. We arrange them vertically, but other geometries might be used.

The grouping of phase shifter in stage for the 2-D case will be similar but for M outputs in the second direction. We just provide a M-sized binary tree phased array for each of the outputs of an initial 1-D 1×N binary tree phased array output. This provides M×N outputs. FIG. 9C shows an example of the 2-D binary tree phased array.

And in step 140, we configure and control the phase shifting. This step can be repeated as necessary. Again, we begin the discussion with the 1-D case. We start first with a general case and further discuss other important refinements. There are N unique signal paths through the binary tree phased array. Depending on the particular signal path from the input to one of the outputs, it passes though all A phase shifters, some mixture or A and B phase shifters, or all B phase shifters. Thus, as the signal progresses through the stages along a signal path, the phase shifts constructively add (and/or subtract). The A phase shifters provide a first phase augmentation, variable A. The B phase shifters provide a second phase augmentation, variable B. These phase augmentations may be a phase delay or phase addition.

In the general case, variables A and B range from 0 to 2π radians. In refinements, they can range from 0 to ±π radians because variable A and B are complimentary; that is, applying a phase shift to one set of phase shifters is equivalent to applying the negative phase shift to the other set of phase shifters. This produces a ramped output based on the phase shifts for A and B. More particularly, applying a positive phase shift to the A set generates a positive slope in the final outputs; applying positive phase shift to the B set generates a negative slope in the final outputs. But the positive and negative slopes here are just a convention, something to contrast the two.

### General Case

In the general scheme, for each stage, Stage n:

A-type phase shift=(2ⁿ*Δϕ*A); and

B-type phase shift=(2ⁿ*Δϕ*B) (2)

Thus, at Stage 0, the A-type phase shift is 1×ΔϕA and the B-type phase shift is 1×ΔϕB. At Stage 1, they are 2×ΔϕA and 2×ΔϕB. At Stage 2, they are 2×ΔϕA and 4×ΔϕB. At Stage 3, they are 8×ΔφA and 8×ΔϕB And so forth

For a 2-D case, we use the same equations for each Stage m using variables C and D instead of A and B. (See FIG. 9B).

There are other important refinements which can be implemented in various embodiments as follows:

### Refinement 1

Adding or subtracting multiples of 2π to the total phase shift applied in each stage has no relative affect on the output of the entire tree, because phase wraps in the domain [0, 2π]. So, for example, if you need A=0.6π radians, then Stage_0 would get a 0.6πA_side phase shift, stage_1 would get a 1.2πA_side phase shift, and Stage_2 would get a 2.4πA_side phase shift. But one could choose to replace the stage 2's A_side phase shift with 2.4π−2π=0.4π, instead. In this way, you only ever need phase shifters capable of [0, 2π]. If the phase is 2π, one can use the modulo (MOD) function to limit. This function effectively takes into account the periodic wrap around.

Thus, for each stage, Stage n:

A-type phase shift=(2ⁿ*Δϕ*A)MOD 2π; and

B-type phase shift=(2ⁿ*Δϕ*B)MOD 2π (3)

And, for a 2-D case, we use the same equations for each Stage m.

### Refinement 2

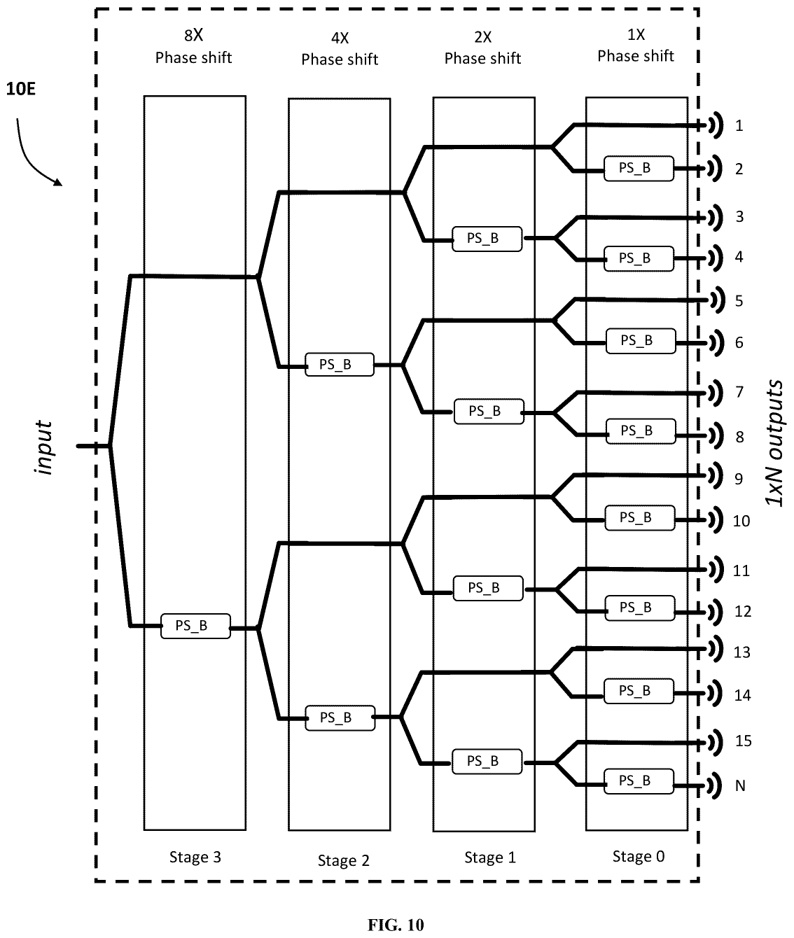

We have found that what really matters is the net phase difference between A_side and B_side in each stage: A_side−B_side. Examining a positive slope case for the moment: You can choose to apply [0, 2π] to the A-side with [0, 0] to B-side to equivalently achieve A−B=[0, 2π] or you could apply [0, ±π] to A_side with [0] to B_side when you desire A−B=[0, π], then its compliment of 2π−(A−B)=[0, π] to B_side with [0, 0] to A_side when you desire A−B=[1π, 2π], because this condition could be alternatively viewed as [−π, 0]. This is allowed because (again) adding or subtracting multiples of 2π to all the shifters in each stage has no net effect on the [0, 2π] wrapped output domain. In this way, you only ever need phase shifters capable of [0, ±π] in range. If the desired phase shift is 0, the associated phase shifter could be removed. This would reduce the phase shifters and control lines each by half from what was earlier discussed. For instance, either the A or B set of phase shifters set to 0 radians could be removed. (See FIG. 10).

In a more practical system, though, a user may want to actively steer the beam to an arbitrary direction, so any phase shifter set that could coincidently need 0 phase shift for one steering angle would generally need to switch to non-zero a moment later. One point to clarify is that when you apply a phase shift in the one group in a stage, you should apply no phase shift to the other group in that same stage. Otherwise, they would be unnecessarily compensating each other.

Here, for each stage, Stage n:

A-type phase shift=0; and

B-type phase shift=(2ⁿ*Δϕ*B)MOD π (4a)

or

A-type phase shift=(2ⁿ*Δϕ*A)MOD π; and

B-type phase shift=0 (4b)

And, for a 2-D case, we use the same equations for each Stage m.

This methodology may be applicable to any situation in which a 1- or 2-dimensional array of signals is needed with a controllable linear phase distribution. In the past, the most prominent applications would be in RF phased array radars and optical phased arrays. RF phased array radars have been used for threat warning and tracking situations.

In the embodiments for these refinements, which we built and tested, we chose to use thermo-optic phase shifters. For Refinement 1, we only ever need them to operate [0, 2π], saving length and power. But, for Refinement 2, we only need half that range [0, ±π], saving half that power (and potentially length). Also, operating the phase shifters over only half their range means that any performance variance due to manufacturing is also cut in half, resulting in a more ideal phase ramp output. While other phase shifting mechanisms exist, these power savings, length savings, and robustness to manufacturing improvements are similar. The fact that each stage is separately connected means that adjustments can be applied to optimize the output ramp, as needed.

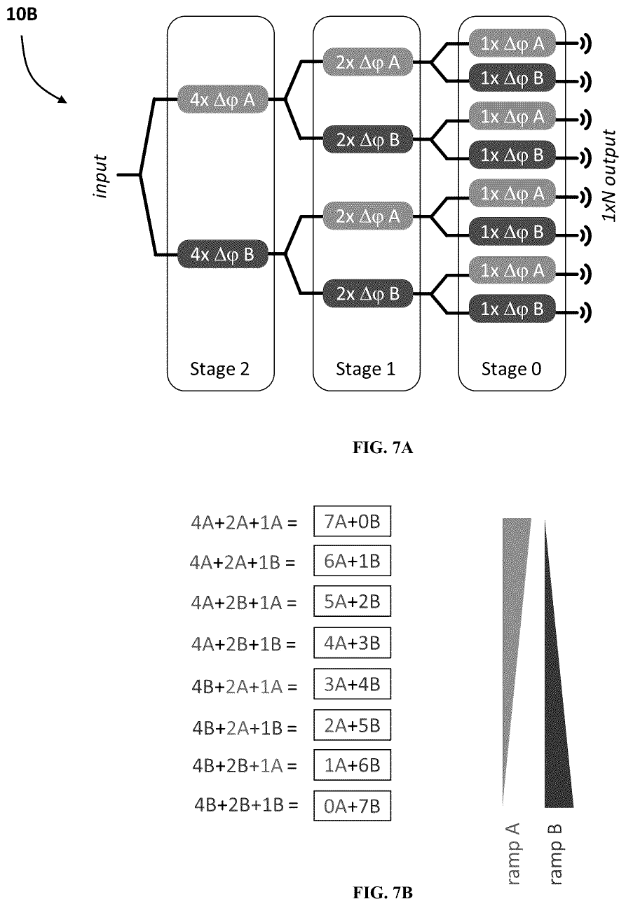

FIG. 7A shows a schematic of a 1-D binary tree phased array embodiment 10B having a single signal input and 8 outputs. We will now discuss its structure and operation. This phased array is composed of three binary tree stages: we label them Stage 0, Stage 1, and Stage 2 for each stage going away from the outputs. Stage 0 includes 8 phase shifters, Stage 1 includes 4 phases shifters, and Stage 2 included two phase shifters. They are grouped into two groups: We call them A and B. The amount of phase shifting in each stage varies. In Stage 0 the phase shifters provide 1× phase shifting. In Stage 1, that is doubled to 2×. And, in Stage 2, doubled again to 4×.

The accumulated phase for each signal path (route) from the signal input to each element in the output array creates a discretely sampled linear ramp distribution. The output is a1×8 array. This ramp is shown in FIG. 7B. The slope of the ramp is dictated by the initial phase shift values chosen for variables A and B. In some implementations, the controller is configured to provide control signals to the stages so that A phase shifters PS_A impart a first linear phase ramp and the B phase shifters PS_B impart a second linear phase ramp. The first and second linear phase ramps may be positive or negative in certain cases. However, this is not a requirement in all cases. The ramps need not be positive or negative and can be any sloped values.

FIG. 8 shows a photonic schematic of a 1-D binary tree phased array embodiment 10C for light having 128 outputs. FIGS. 8A and 8D are magnified views thereof. The output array here is 1×128. It is composed of seven stages: Stage 0 to Stage 6. More, it is composed of a binary tree of optical waveguides with integrated phase shifters on the left-hand-side and an emitter grating array on the right-hand-side. The phase shifters for groups A and B and the vertical grating emitter may be the same hardware elements, for instance, as described in T. Komljenovic et al., “Sparse aperiodic arrays for optical beam forming and LIDAR,” Optics Express, Vol. 25, No. 3, 2017, herein incorporated by reference in its entirety.

The labeled squares to the top and bottom are contact pads to electrically connect to each of the phase control stages. A1 and B1 here correspond to the complementary sets of phase shifters of the stage closest to the outputs (Stage 0) in the illustration, while A7 and B7 here are for the stage nearest the input (Stage 6). These control N=128 (2⁷) vertical emitters with a 2-micron pitch. FIG. 8A is a magnified view of one of the thermo-optic phase shifters chosen for this embodiment. It uses a doped silicon heater to locally increases the temperature of the adjacent silicon optical waveguide, which causes the light to experience a positive phase shift. FIG. 8B is a magnified view of the vertical grating emitter array chosen for this implementation. The grating emitters scatter light vertically out into the farfield. Their entire length is used for this purpose.

FIGS. 9A-9C show a 2-D binary tree phased array with 4×8 outputs according to an embodiment. This is for the case of M=4 (2²) by N=8 (2³) case. FIG. 9A shows a binary tree phased array for a 1×8 output. It is oriented in a first dimension. FIG. 9B shows a binary tree phased array for a 4×1 output. It is oriented in a second dimension which is orthogonal to the first one in FIG. 9A. There will be one of the phased arrays in FIG. 9B for each of the outputs in FIG. 9A; so, eight of these will be used. By putting these phased arrays together as shown in FIG. 9C, the 2-D binary tree phased array with 4×8 outputs is formed. This small case was chosen for clarity of the concept. Although, a 2-D array M×N can scale well beyond this small illustrative case. They use variable C and D for the phase shifting. These are similar to variable A and B discussed above.

FIG. 10 is a schematic of a 1-D binary tree phased array embodiment 10E which uses just one group of phase shifters. Here, we started with the design shown in FIG. 2. Using Refinement 2, Equation 4(a), we set the phase shifting of the A group of phase shifter (PS_A) and the B group of phase shifters (PS_B). Per that equation, the phase shifting of the A group of phase shifter (PS_A) is set to 0 radians. The phase shifting thus will be entirely provided by the B group of phase shifters (PS_B). By doing so, the A group phase shifters can be effectively eliminated from phased array and, as illustrated, have been in this embodiment 10E. It is noted the opposite configuration could also be provided for in other embodiments, that is, the phased shifting of the PS_B phase shifters set to zero radians per Equation 4(b) and can be eliminated; only the PS_A phased shifters would be used then.

This elimination can reduce the number of phase shifters and control lines by half. Thus, there could be as few as log₂(N) control lines to the plurality of phase shifters. And assuming those phase shifters can use the same control signals, there may be as few as one control line to the plurality of phase shifters. Additional hardware modifications would be necessary to account for the latter implementation as mentioned above.

We have implemented embodiments of the present invention in an integrated photonics platform to generate optical phased arrays. For simplicity, we used thermo-optic phenomena-based phase shifters, but envision using other types of phase shifter elements, such as electro-optic ones. Thermo-optic phase shifters can only add phase (not subtract), so in our implementation we access the negative phase distribution slopes in the output array (that we need to steer the beam) by systematically applying power to a mixture of A and B phase shifters amongst the stages. It turns out to be more efficient to apply only 0 to +r phase shift to a mixture of stages, rather than 0 to +2π to just the A phase shifters to achieve a “positive” slope or 0 to +2π to just the B stages to achieve a “negative” slope. The efficiency improvement of the mixed approach is allowed because of phase-wrapping. This is the basis for our Refinement 2, which should be understandable by those skilled in the art.

All the A phase shifters in Stage 0 are tied or connected together, same for B. They may have electrical control lines or other means depending on the phase shifters used. Same for each of the other stages. This is how we achieve only needing 2 control lines per stage in some embodiments. In other embodiments, it may be possible to connect all A stages together with a single control line for the entire array and the same for all the B stages. The stages themselves may be further configured to provide multiples of the phase shifting for each stage. For example, one could use transistors, amplifiers, resistor networks, etc., try to achieve twice the phase in Stage 1's shifters as in Stage 0, and 4 times the phase in Stage 2's shifters as in Stage 0, and so on, with the same control line and signal. In this arrangement, only two control lines may be theoretically necessary for the entire phased array: one for the PS_As and one for the PS_Bs across all stages.

The phased arrays according to embodiments of the present invention have many applications, including but not necessarily limited to optical phased arrays for LIDAR (for terrain mapping, collision avoidance, self-driving vehicles, etc.); optical phased arrays for steerable free-space optical communications; RF phased arrays for radar systems; and RF phased arrays for steerable directional RF communications. Likewise, they are applicable to any other situation where one wants to control a linear phase shift distribution (e.g., sound or otherwise).

Optical phased arrays have been investigated for future steerable optical communications and lidar for terrain mapping (as a navigational aid). We are focusing on creating chip-scale steerable optical communications systems to augment or supplant RF communications. The most prominent future use for optical phased arrays is for automatic lidar for self-driving vehicles. Many self-driving vehicles use low Size, Weight, Power and Cost (SWaP-C) lidar system for navigation. The aforementioned embodiments drastically reduce the peripheral control electronics, assembly, and calibration complexity of state-of-the-art approaches. The ones we have fabricated are a few times smaller in size, resulting in a respective reduction in production cost.

We further envision the novel binary tree phased arrays being implemented in other ways, such as in chip-scale optical phased array beam steerers. This technology greatly reduces the control complexity of such systems, simplifies calibration, reduces power consumption, reduces size and cost, and improves manufacturing robustness; all of which are highly desired. In some embodiments, the binary tree fed phased arrays can be used in reverse to coherently combine a remote signal in the farfield collected by the phased antenna array. This is beneficial for lidar and radar applications.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, and to describe the actual partial implementation in the laboratory of the system which was assembled using a combination of existing equipment and equipment that could be readily obtained by the inventors, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

We claim:

1. A phased array comprising:
a signal input;
N signal outputs, where N is an even number of at least 4;
a binary tree comprising a plurality of stages between the signal input and the N signal outputs, the stage closest to the signal input receiving the signal input, each consecutive stage receiving the outputs of the preceding stage, and the last stage connecting to the N signal outputs;
a plurality of phase shifters to apply a phase shift to signals in the binary tree, with each stage distributing the signal to each of its phase shifters, wherein
the first stage closest to the signal input including two phase shifters, each consecutive stage including twice as many phase shifters as the previous one, and the last stage including N phase shifters which connect to the N signal outputs, and
half the phase shifters in each stage are associated with a first group and the other half of phase shifters in each stage are associated with a second group; and
a controller configured to provide control signals to the phase shifters, the controller providing a first control signal to the first group of shifters at each stage and a second control signal to the second group of phase shifters at each stage, the control signals being further configured to provide an initial amount of phase shifting at the stage closest to the N signal outputs and effectively doubling amount of that initial phase shifting amount for each consecutive stage closer to the signal input.

2. The phased array of claim 1, wherein the first control signals provide a first linear phase ramp and the second control signals provide a second linear phase ramp.

3. The phased array of claim 1, wherein the amount of phase shifting for the phase shifters at each stage is between 0 and 2π radians.

4. The phased array of claim 1, wherein the amount of phase shifting for the phase shifters at each stage is between 0 and ±π radians.

5. The phased array of claim 1, wherein there are 2*log₂(N) control lines to the plurality of phase shifters.

6. The phased array of claim 1, wherein there are 2 control lines to the plurality of phase shifters.

7. The phased array of claim 1, wherein the signal input is a radio frequency, light or acoustic signal.

8. The phased array of claim 1, wherein the output array is one-dimensional, 1×N.

9. The phased array of claim 1, wherein the output array is two-dimensional, M×N, where M is an even number of at least 4.

10. The phased array of claim 9, further comprising a plurality of second binary tree phased arrays comprising a plurality of stages between 1×N signal inputs and M×N signal outputs, the stage closest to 1×N signal inputs receiving the 1×N signal inputs, each consecutive stage receiving the outputs of the preceding stage, and the last stage connected to the M×N signal outputs.

11. The phased array of claim 1, further comprising a plurality of signal splitters to split signals for each stage; and wherein the controller is configured to also control the phase shifters to correct to variations on the output of the signal splitters.

12. A phased array comprising:
a signal input;
N signal outputs, where N is an even number of at least 4;
a binary tree comprising a plurality of stages between the signal input and the N signal outputs, the stage closest to the signal input receiving the signal input, each consecutive stage receiving the outputs of the preceding stage, and the last stage connecting to the N signal outputs;
a plurality of phase shifters to apply a phase shift to signals in the binary tree, with each stage distributing the signal to each of its phase shifters, wherein
the first stage closest to the signal input including at least one phase shifter, each consecutive stage including twice as many phase shifters as the previous one, and the last stage connecting to the N signal outputs; and
a controller configured to provide control signals to the phase shifters, the controller providing a control signal to phase shifter(s) at each stage, the control signals being further configured to provide an initial amount of phase shifting at stage closest to the N signal outputs and effectively doubling amount of that initial phase shifting amount for each consecutive stage closer to the signal input.

13. The phased array of claim 12, wherein the phase shifters in each stage are associated as a single group.

14. The phased array of claim 13, wherein there are log₂(N) control lines to the plurality of phase shifters.

15. The phased array of claim 13, wherein there is one control line to the plurality of phase shifters.

16. The phased array of claim 12, wherein half the phase shifters in each stage are associated with a first group and the other half of phase shifters in each stage are associated with a second group; and the controller is configured to provide control signals to the phase shifters, the controller providing a first control signal to the first group of shifters at each stage and a second control signal to the second group of phase shifters at each stage.

17. A method of forming a phased array according to claim 1 comprising:
decide the number of outputs for the phased array;
determine the number of stages for the phased array based on the number of outputs;
arrange the plurality of phase shifters in the stages to form the binary tree; and
configure and control phase shifting for the phase shifters in each of the stages.

18. A method of using a phased array according to claim 1 comprising:
control the phase shifters of the first group; and
control the phase shifters of the second group.
